(19) United States
(12) Patent Application Publication
(10) Pub. No.: US 2018/0230689 A1
(43) Pub. Date: Aug. 16, 2018

(54) DRAIN CLEANING DEVICE

(71) Applicant: TTI (MACAO COMMERCIAL OFFSHORE) LIMITED, Macau, MO (US)

(72) Inventor: Graham M. Schaafsma, Raleigh, NC (US)

(21) Appl. No.: 15/895,101

(22) Filed: Feb. 13, 2018

Related U.S. Application Data
(60) Provisional application No. 62/458,452, filed on Feb. 13, 2017.

(51) Int. Cl. E03F 9/00; B08B 9/045; F16D 1/112; E03C 1/302

(52) U.S. Cl. CPC E03F 9/005; B08B 9/045; B08B 2209/04; E03C 1/302; F16D 1/112

(57) ABSTRACT

A drain cleaner including a snake configured to be inserted into a drain, a conduit through which the snake extends, where the conduit includes an attachment member, and a linkage including a first engagement element on a first end and a second engagement element on a second end opposite the first end. The first engagement element is coupled to the attachment member of the conduit. The drain cleaner further includes an adapter having a first end coupled to the second engagement element of the linkage and a second end configured to be received by an operation portion of a power tool.

### CROSS-REFERENCE TO RELATED APPLICATIONS

The present application claims priority to U.S. Provisional Patent Application No. 62/458,452, filed Feb. 13, 2017, the entire contents of which are incorporated by reference herein.

### FIELD OF INVENTION

The present invention relates to drain cleaning devices.

### BACKGROUND

Drain cleaners and drain uncloggers are generally known, and typically include an elongated cable or snake that is inserted into a drain. The snake is used to collect debris, such as hair, dirt, and other material, that is caught in the drain causing fluid back up. Generally the snake is extended into the drain and is twisted or rotated in order to collect the debris on the end of the snake. Once the debris attaches to the snake, the snake is retracted from the drain, removing the debris with it.

There are generally two different types of drain cleaners, including manual drain cleaners and motor driven drain cleaners. Manual drain cleaners include a snake and a handle portion for the user to control the snake. The user inserts the drain cleaner into the drain and then manually twists and maneuvers the snake to collect debris. Manual drain cleaners are compact and inexpensive compared to motor driven drain cleaners. However, on occasion it can be difficult to create enough force and torque on the snake to break up the clog using a manual drain cleaner. Motor driven drain cleaners are more robust than manual drain cleaners. Motor driven drain cleaners include a housing having a handle and a motor, a rotatable drum that houses a large snake, and a nose assembly that guides the snake into the drain. Rotation of the drum causes rotation of the snake within the drain. The motor drives rotation of the drum and exerts a torque on the snake to break up the clog and collect the debris. While motor driven drain cleaners can be more effective at breaking up clogs than manual drain cleaners, they are larger and more expensive than manual drain cleaners.

### SUMMARY OF THE INVENTION

In one embodiment, the invention provides a drain cleaner including a snake configured to be inserted into a drain, a conduit through which the snake extends, where the conduit includes an attachment member, and a linkage including a first engagement element on a first end and a second engagement element on a second end opposite the first end. The first engagement element is coupled to the attachment member of the conduit. The drain cleaner further includes an adapter having a first end coupled to the second engagement element of the linkage and a second end configured to be received by an operation portion of a power tool.

In another embodiment, the invention provides a drain cleaner including a snake configured to be inserted into a drain, and an adapter including a first end and a second end, where the first end configured to be received by an operation portion of a power tool. A passageway extends between the first end and the second end, and the passageway receives the snake. A plurality of slits extend along the first end of the adapter, where the slits are compressible when the first end of the adapter is received by the operation portion of the power tool.

In yet another embodiment, the invention provides a drain cleaner including a snake having a first end and a second end, where the first end is configured to be inserted into a drain, and a conduit having a first end and a second end, the snake extending through the conduit with a first end of the snake extending beyond the first end of the conduit and a second end of the snake extending beyond a second end of the conduit. An adapter includes a passage that receives the second end of the snake, where the first end of the adaptor is configured to be received by an operation portion of a power tool. The adaptor includes a clamp member to fixedly secure the second end of the snake relative to the adapter.

Other aspects of the invention will become apparent by consideration of the detailed description and accompanying drawings.

### BRIEF DESCRIPTION OF THE DRAWINGS

FIG. 1 is a perspective view of a drain cleaning device according to one embodiment.

FIG. 2 is an exploded view of the drain cleaning device of FIG. 1.

FIG. 3 is a detailed view of a first end a snake assembly according to one embodiment.

FIG. 4 is a detailed view of a second end of the snake assembly according to one embodiment.

FIG. 5 is a first perspective view of a linkage according to one embodiment.

FIG. 6 is a second perspective view of the linkage of FIG. 5.

FIG. 7 is a cross-sectional view of the linkage taken along section line 7-7 of FIG. 6.

FIG. 8 is a first perspective view of an adapter according to one embodiment.

FIG. 9 is a second perspective view of the adapter of FIG. 8.

FIG. 10 is a side view of the adapter of FIG. 8.

FIG. 11 is a cross-sectional view of the adapter taken along section line 11-11 of FIG. 10.

FIG. 12 is a cross-sectional view of a portion of a cable assembly taken along section line 1-1 of FIG. 1.

FIG. 13 is a cross-sectional view of the portion of the cable assembly and the connection member taken along section line 1-1 of FIG. 1.

FIG. 14 is a cross-sectional view of the portion of the cable assembly, the connection member, and the adapter taken along section line 1-1 of FIG. 1.

FIG. 15 is a perspective view of a linkage and an adapter according to another embodiment.

FIG. 16 is an exploded view of the linkage and the adapter shown in FIG. 15.

FIG. 17 is a perspective view of a first linkage member.

FIG. 18 is another perspective view of the first linkage member shown in FIG. 17.

FIG. 19 is a perspective view of a second linkage member.

FIG. 20 is another perspective view of the second linkage member shown in FIG. 19.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

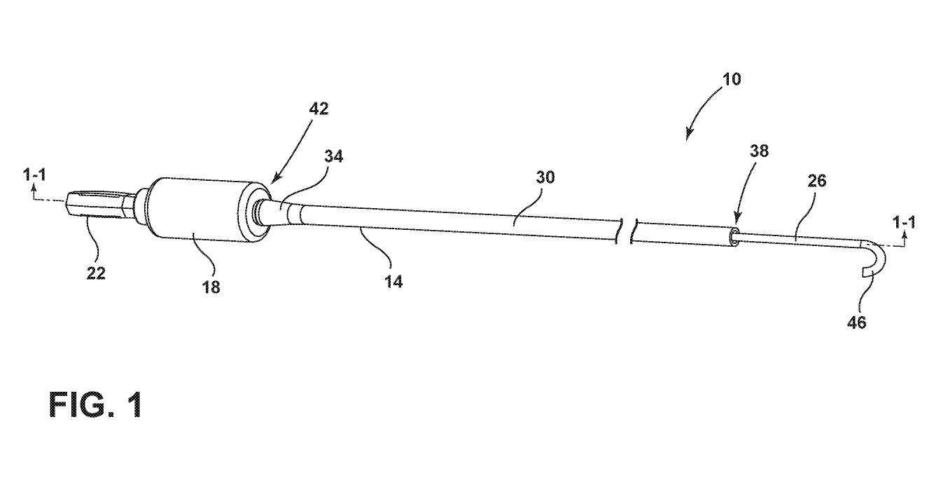

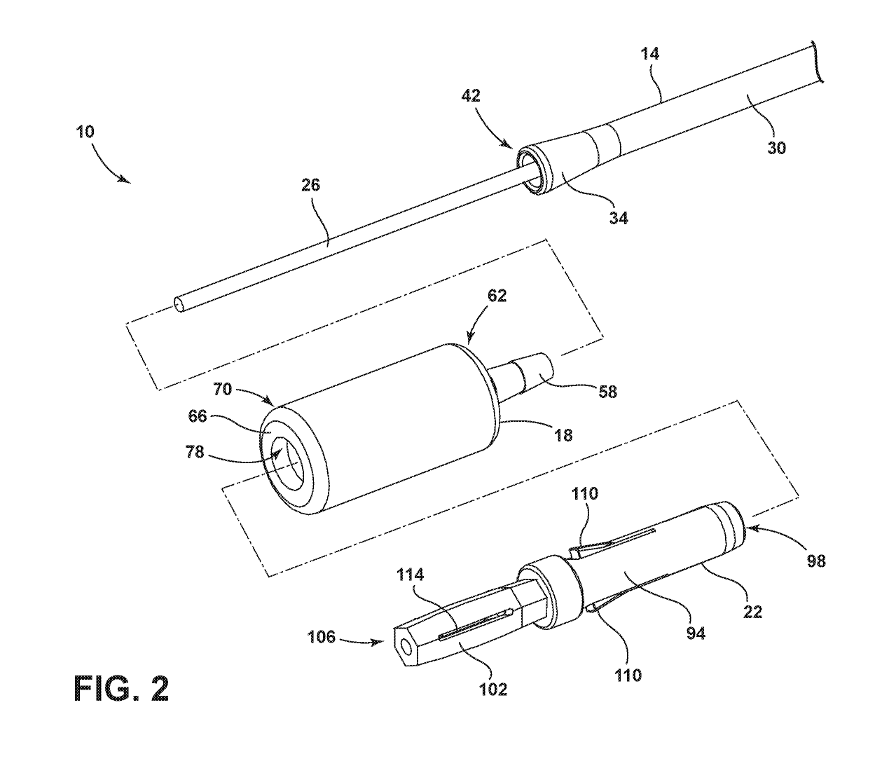

FIGS. 1 and 2 illustrate a drain cleaning device 10 according to one embodiment. The drain cleaning device 10 includes a snake assembly 14, a linkage 18, and an adapter 22. The snake assembly 14 extends into the drain to break up clogs and remove debris. The linkage 18 connects snake assembly 14 to the adapter 22. The adapter 22 is received by a power tool so that a motor of the power tool can drive the rotation of the snake assembly 14. For example, the adapter 22 can be received by a chuck of a power tool, such as a drill driver.

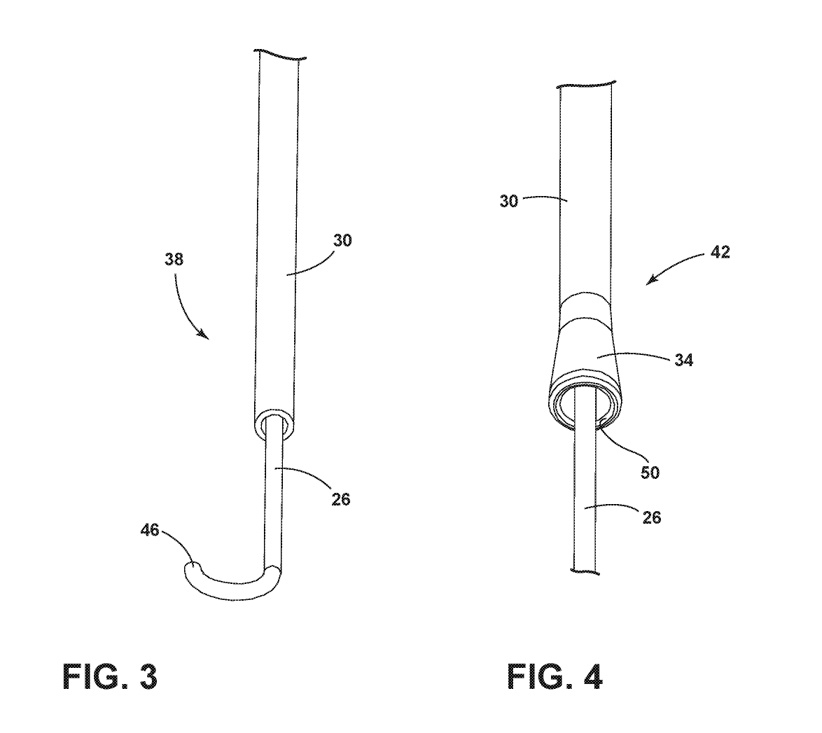

The snake assembly 14 includes an elongated snake 26, a conduit 30 through which the snake 26 extends, and an attachment member 34 for engaging with the linkage 18. The snake 26 can be extended into a drain to collect debris. FIG. 3 illustrates a first end 38 of the snake assembly 14. As shown, the snake 26 extends beyond the end of the conduit 30. The snake 26 has a gripping member 46 on the end of the snake 26 to help break up and collect debris. In the illustrated embodiment, the gripping member 46 is a hook. However, in other embodiments, the gripping member 46 can be other elements that assist in gripping the debris. In addition, in some embodiments, other types of accessories can be attached to the end of the snake 26. For example, a coil or a cutter can be attached to the end of the snake 26.

FIG. 4 illustrates a second end 42 of the snake assembly 14. In the illustrated embodiment, the snake 26 extends beyond the end of the conduit 30 on the second end 42. However, in other embodiments, the snake 26 is fully enclosed within the conduit 30 on the second end 42 of the snake assembly 14 and does not extend beyond the conduit 30. The second end of the snake assembly 14 includes the attachment member 34. In the illustrated embodiment, the attachment member 34 extends from the end of the conduit 30. The attachment member 34 flares outwardly to form a female receiving part. In addition, the attachment member 34 includes an annular protrusion 50 extending radially inward. The annular protrusion 50 helps to secure the attachment member 34 to the linkage 18. In some embodiments, the snake assembly 14 may not include a conduit 30, and the attachment member 34 may be coupled directly to the snake 26. In the illustrated embodiment, the attachment member 34 includes two annular protrusions 50. However, in other embodiments, the attachment member 34 may include a fewer or greater number of annular protrusions 50. In some embodiments, the annular protrusions 50 extend around the entire inner circumference of the conduit 30, while in other embodiments, the annular protrusions 50 only extend around a portion of the inner circumference of the conduit 30.

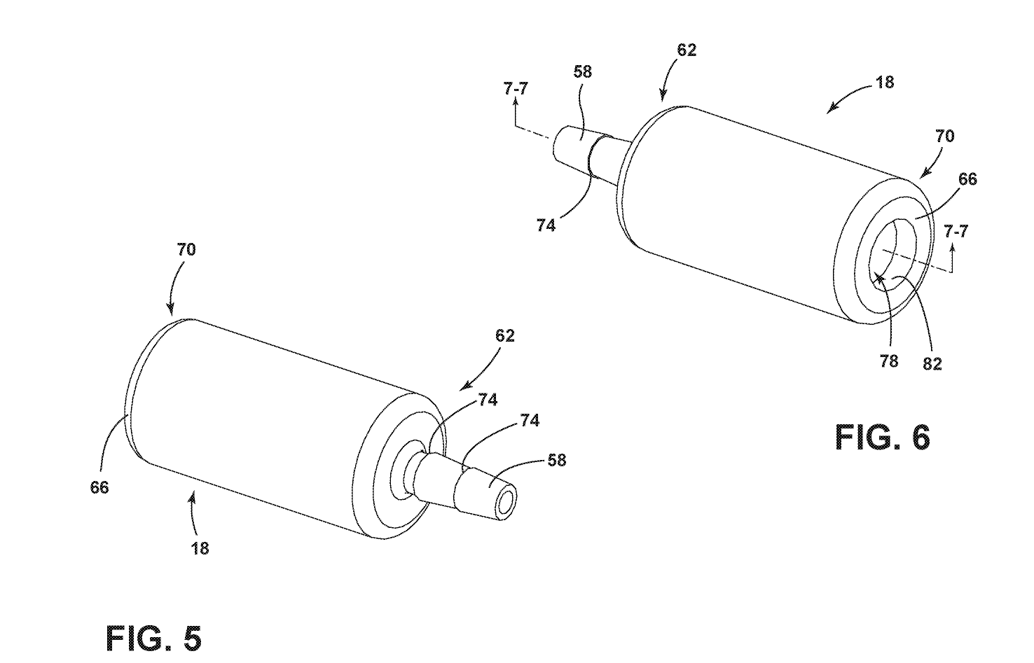

The attachment member 34 is configured to engage with the linkage 18 to couple the snake assembly 14 to the linkage 18. With reference to FIGS. 5-7, the linkage 18 has a generally cylindrical shape. In the illustrated embodiment, the linkage 18 includes a hollow cavity 54 and enables the snake 26 to be threaded through the entire length of the linkage 18.

The linkage 18 includes a first engagement element 58 on a first end 62 and a second engagement element 66 on a second end 70. The first engagement element 58 is configured to engage with the attachment member 34 of the snake assembly 14, and the second engagement element 66 is configured to engage with the adapter 22. In the illustrated embodiment, the first engagement element 58 is elongated and forms a male insertion part. The first engagement element 58 is received by the female part of the attachment member 34 on the snake assembly 14. In other embodiments, the male and female parts can be reversed so that the snake assembly 14 includes the male part and the linkage 18 includes the female part.

In the illustrated embodiment, the first engagement element 58 is snap fit into the attachment member 34. More specifically, the first engagement element 58 is tapered so that it can more easily be inserted into the attachment member 34. The first engagement element 58 is cylindrical and includes annular ridges 74 to help secure the linkage 18 to the snake assembly 14. The annular ridges 74 of the first engagement element 58 engage with the annular protrusions 50 of the attachment member 34 to secure the linkage 18 to the snake assembly 14. The illustrated embodiment includes two annular ridges 74 that engage with the protrusions 50, however, in other embodiments, a fewer or greater number of ridges 74 can be included on the first engagement element 58. Because of the cylindrical shape, the first engagement element 58 is able to rotate within and relative to the attachment member 34. In other embodiments, different types of couplings can be used as the first engagement element 58.

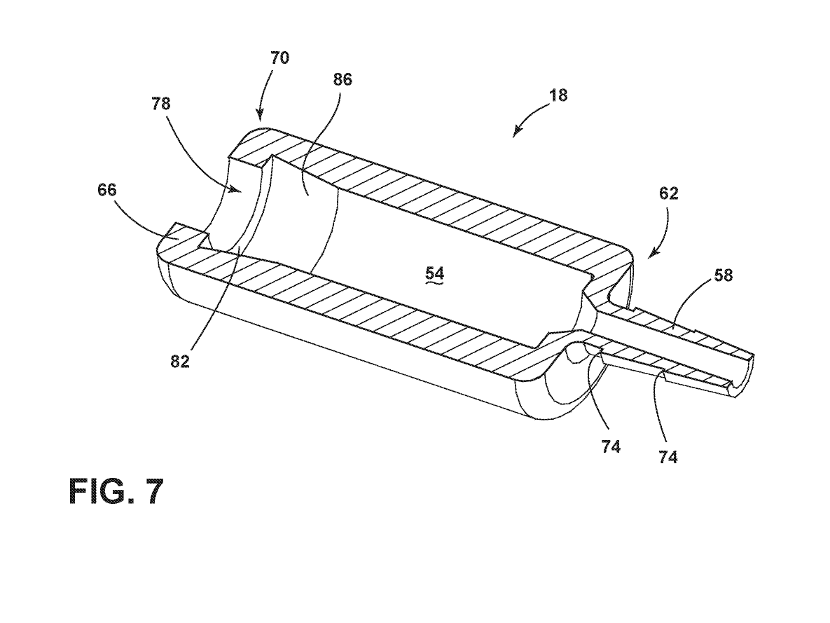

With reference to FIG. 7, the second engagement element 66 is positioned on the opposite side of the linkage 18 as the first engagement element 58 and is configured to receive the adapter 22. The second engagement element 66 is formed by the shape of the linkage 18. More specifically, the second engagement element 66 includes an aperture 78 for receiving the adapter 22, and an annular lip 82 for securing the adapter 22 within the linkage 18. In addition, the second engagement element 66 includes a tapered portion 86 for receiving the adapter 22.

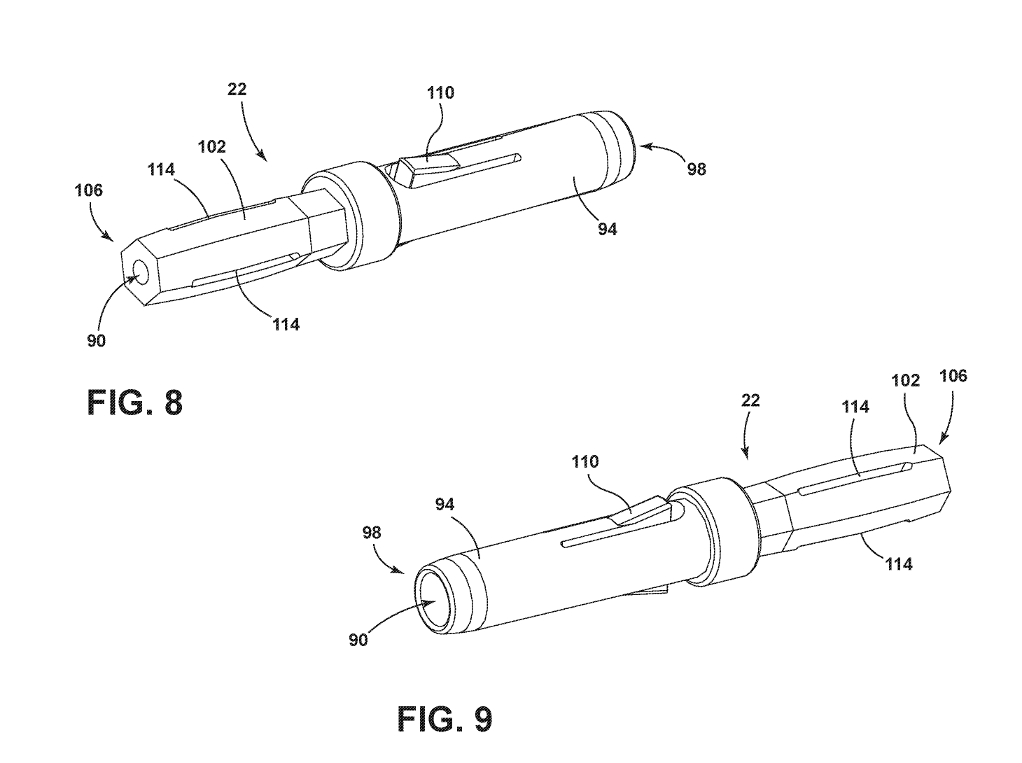

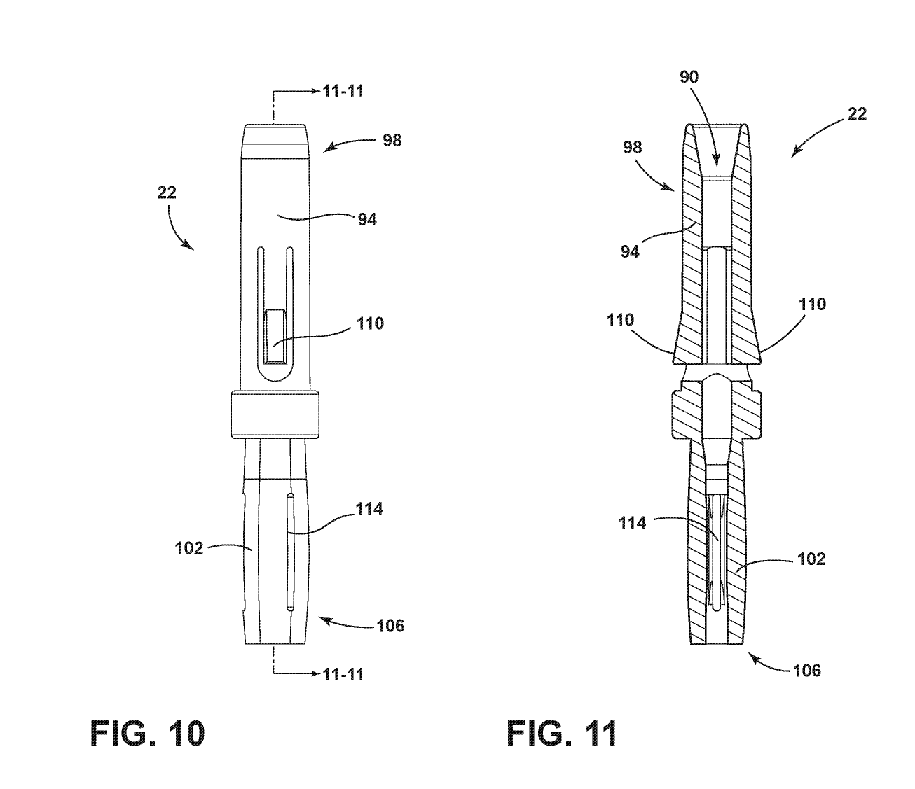

Referring to FIGS. 8-11, the illustrated adapter 22 is elongated and defines a hollow passageway 90 for receiving the snake 26. The adapter 22 includes a connecting portion 94 on a first end 98 and a collet 102 on a second end 106 of the adapter 22. The snake 26 extends through the connecting portion 94 and into the collet 102 of the adapter 22. The connecting portion 94 is sized and shaped to be received within the linkage 18. Specifically, the connecting portion 94 is inserted into the aperture 78 (FIG. 7) of the second engagement element 66. The connecting portion 94 includes connecting elements 110 that engage with the annular lip 82 of the second engagement element 66 to lock the adapter 22 within the linkage 18. In the illustrated embodiment, the connecting elements 110 are cantilevered arms that provide a snap fit connection. However, in other embodiments different types of couplings can be used to secure the adapter 22 to the linkage 18. In the illustrated embodiment, the tapered portion 86 of the linkage 18 provides space for the connecting elements 110 so that the adapter 22 can rotate within and relative to the linkage 18.

The collet 102 of the adapter 22 is sized and shaped to be received by a power tool (not shown). In particular, the collet 102 is received by an operational portion of a power tool so that the power tool can transmit rotational force to the adapter 22, to thereby cause rotation of the snake assembly 14. For example, the collet 102 is received within a chuck of a drill. The chuck of the drill will then transmit rotational force to the adapter 22, which will in turn, rotate the snake assembly 14 within a drain. The collet 102 can be hexagonal or any other shape that is designed to fit into a standard power tool. The collet 102 includes slits 114 extending axially along the length of the adapter 22. The slits 114 at least partially divide the collet 102 into jaws that can be compressed and clamp onto the snake 26. The slits 114 also provide additional space within the hollow passageway 90 to make it easier to receive the snake 26 when the collet 102 is not received in a power tool. When the collet 102 is inserted into the power tool, the collet 102 is compressed and the width of the slits 114 is reduced. When the collet 102 is compressed, the snake 26 is clamped within the collet 102 and is fixed relative to the collet 102. Accordingly, when the power tool drives rotation of the collet 102, the force will be transferred to the snake 26 so that the snake 26 will also rotate. As previously mentioned, the adapter 22 can rotate relative to the linkage 18, and the linkage 18 can rotate relative to the attachment member 34. Therefore, when a user grasps the conduit 30 to help maneuver the conduit 30 and the snake 26 within the drain, the snake 26 continues to rotate while the conduit 30 remains fixed.

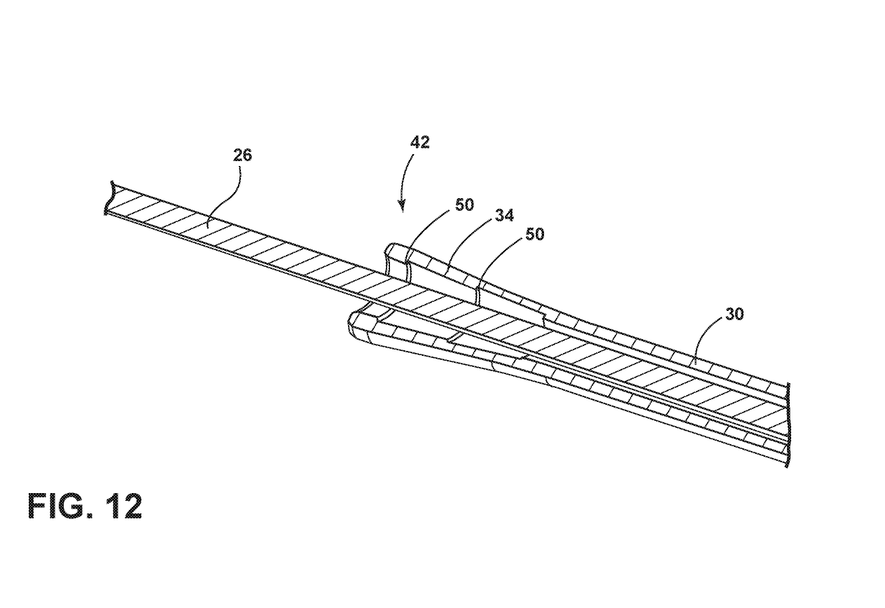

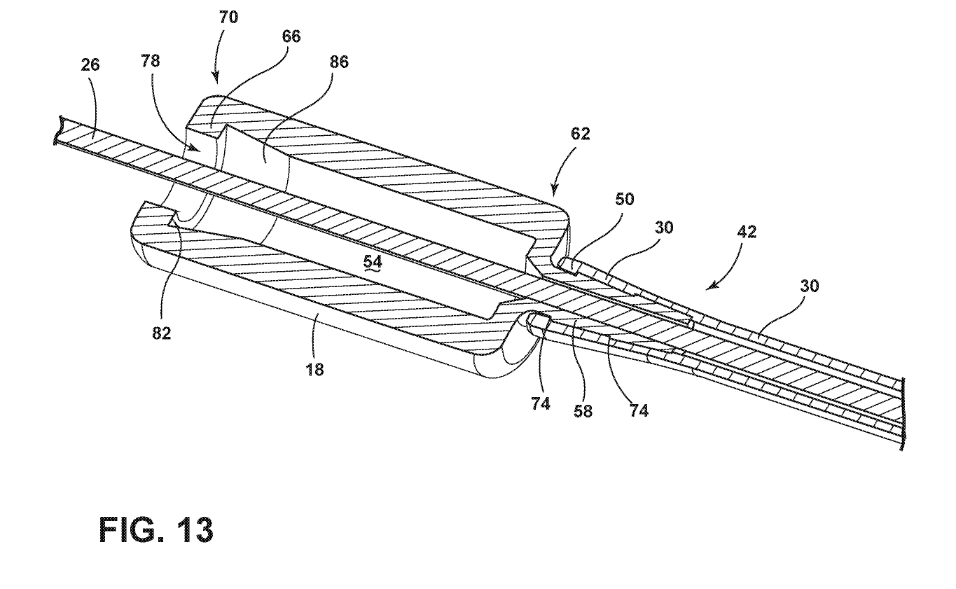

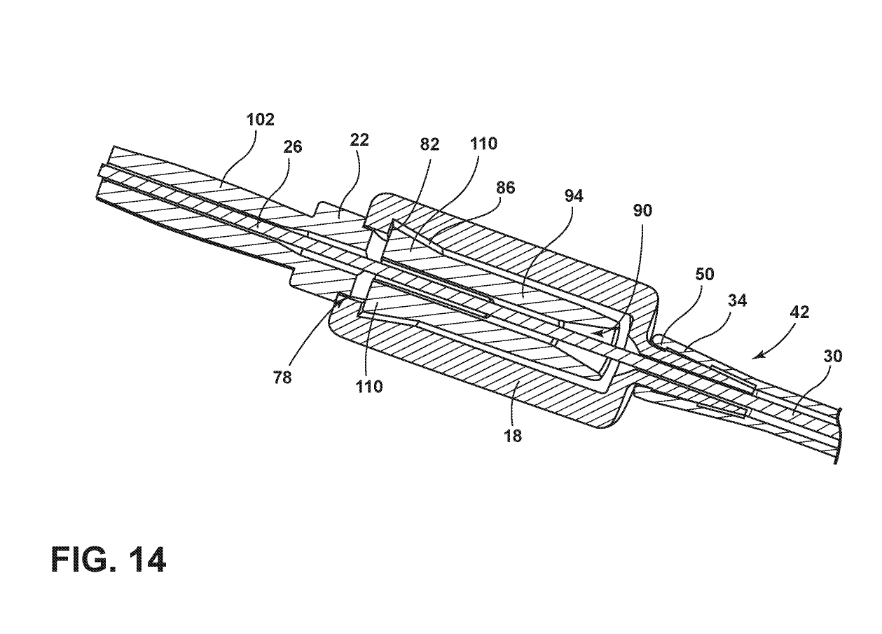

With reference to FIGS. 12-14, the drain cleaning device 10 can be assembled as follows. First, as shown in FIG. 12, the snake 26 is threaded through the conduit 30 to form the snake assembly 14. In the illustrated embodiment, a portion of the snake 26 extends beyond the conduit 30 on each end of the conduit 30. Then, as shown in FIG. 13, the second end of the snake 26 is threaded through linkage 18. The first engagement element 58 of the linkage 18 is slid into the attachment member 34 to secure the linkage 18 to the snake assembly 14. Next, as shown in FIG. 14, the snake 26 is inserted into the adapter 22 with the snake 26 extending into the collet 102. The connecting portion 94 of the collet 102 is snap fit into the second engagement element 66 of the linkage 18. Finally, the collet 102 is inserted into a power tool. As the collet 102 is inserted, the collet 102 compresses and clamps onto the snake 26, securing the snake 26 to the adapter 22. It should be understood by a person of ordinary skill in the art that certain assembly steps can be performed in a different order than described herein. For example, in some embodiments, the snake 26 is threaded through the adapter 22 prior to be threaded through the linkage 18.

In operation, the first end of the snake assembly 14 is inserted into a drain. The power tool can be operated as normal to power the drain cleaning device 10. Specifically, the motor of the power tool drives rotation of the collet 102 to drive rotation of the snake 26 within the drain. This helps break up the clog and collect debris.

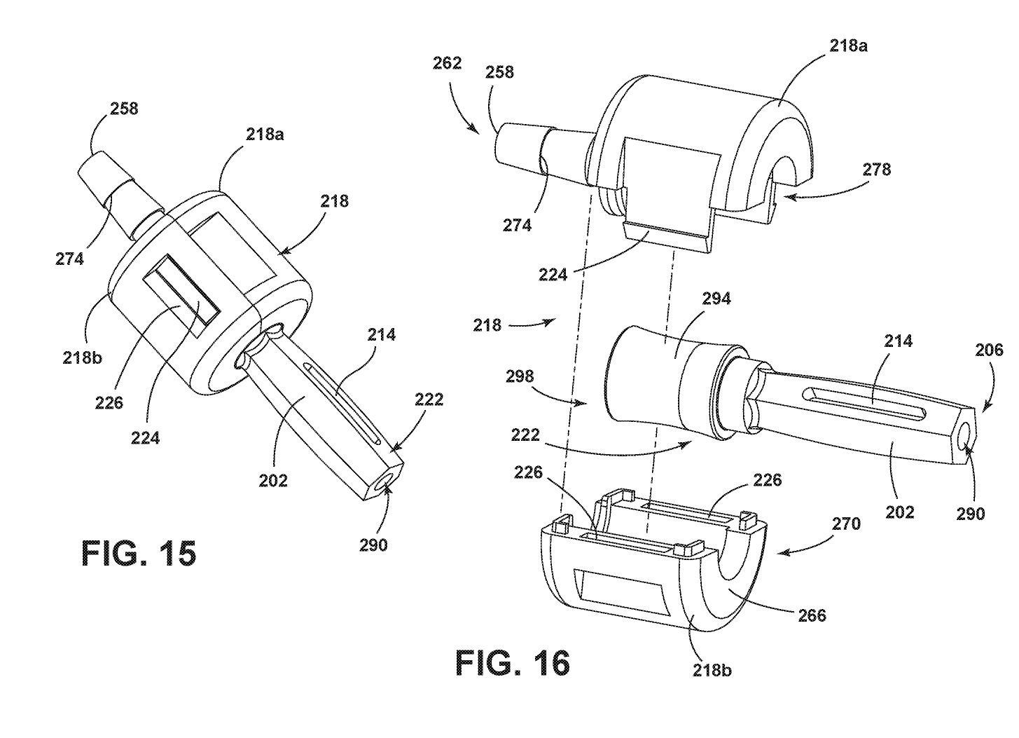

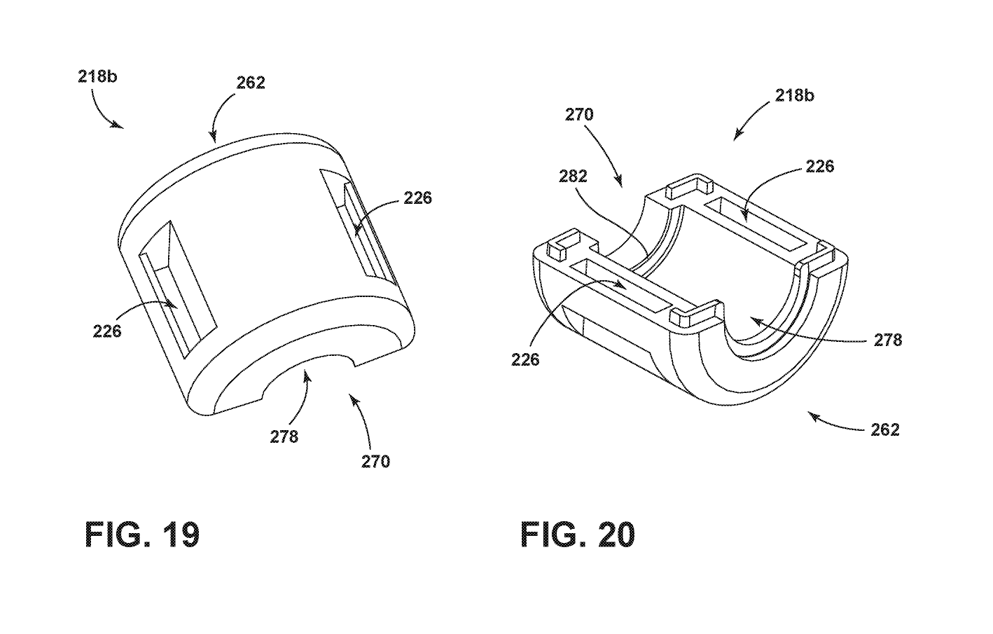

FIGS. 15-20 illustrate another embodiment of a drain cleaning apparatus. Specifically, FIGS. 15-20 illustrate a second embodiment of a linkage 218 and an adapter 222 for use with the snake assembly 14 discussed above. The linkage 218 has a generally cylindrical shape and includes a hollow cavity 254 for receiving the adapter 222. The linkage 218 includes a first engagement element 258 at a first end 262 of the linkage 218, which engages with the attachment member 34 of the snake assembly 14. The linkage 218 further includes a second engagement element 266 at a second end 270 of the linkage 218, which engages with the adapter 222.

In the illustrated embodiment, the first engagement element 258 is elongated and tapered to form a male insertion part, which is received by the female part of the attachment member 34 on the snake assembly 14. In other embodiments, the male and female parts can be reversed so that the snake assembly 14 includes the male part and the linkage 18 includes the female part. The first engagement element 258 is cylindrical and includes annular ridges 274 to help secure the linkage 218 to the snake assembly 14. The annular ridge 274 of the first engagement element 258 engages with the annular protrusion 50 of the attachment member 34 to secure the linkage 18 to the snake assembly 14.

The second engagement element 266 is positioned on the opposite side of the linkage 218 as the first engagement element 258 and receives the adapter 222. The second engagement element 266 includes an aperture 278 for receiving the adapter 222, and an annular lip 282 for retaining the adapter 222 within the linkage 218.

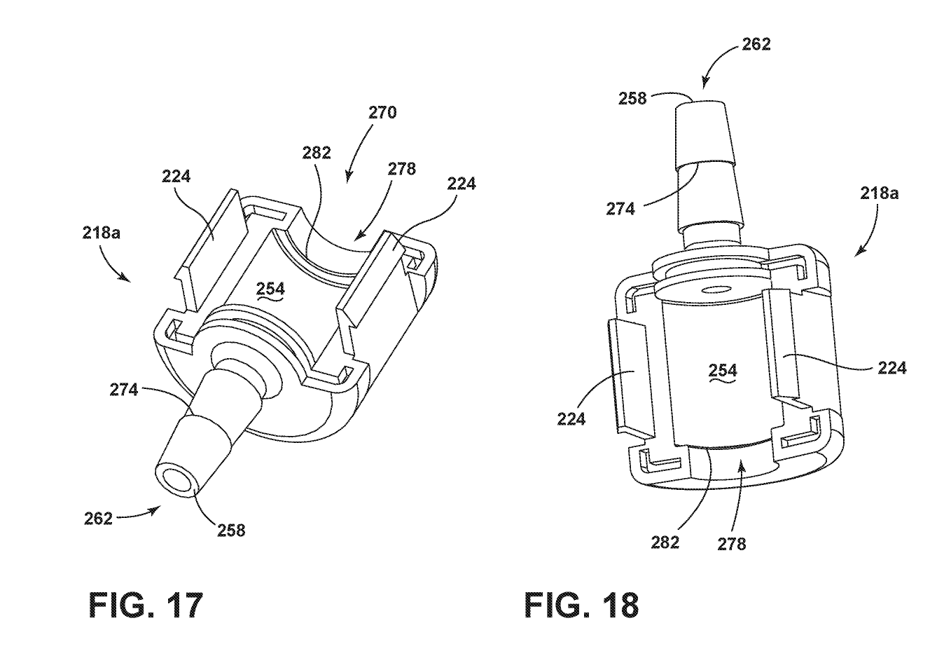

With reference to FIGS. 17-20, the linkage 218 is formed by a first linkage member 218a and a second linkage member 218b, which together form the full linkage 218. In the illustrated embodiment, the first engagement element 258 extends from the first linkage member 218a. The second engagement element 266 is formed by the connection of the first linkage member 218a and the second linkage member 218b. The first linkage member 218a and the second linkage member 218b are coupled together by a tab 224 and a recess 226. In the illustrated embodiment, the first linkage member 218a includes two tabs 226 that are received within two corresponding recesses 226 in the second linkage member 218b. In other embodiments, the tabs 224 can be located on the second linkage member 218b and the recesses 226 can be located on the first linkage member 218a. In other embodiments, other fastening means can be used to connect the first and second linkage members 218a, 281b together.

The illustrated adapter 222 is elongated and defines a hollow passageway 290 for receiving the snake 26. The adapter 222 includes a connecting portion 294 on a first end 298 and a collet 202 on a second end 206 of the adapter 222. The snake 26 can extend through the connecting portion 294 and into the collet 202 of the adapter 222. The connecting portion 294 is sized and shaped to be received within the hollow portion 254 of linkage 218. Specifically, the first linkage member 218a and the second linkage member 218b are coupled together with the connecting portion 294 positioned therebetween in order to secure the adapter 222 within the linkage 218.

The collet 202 of the adapter 222 is sized and shaped to be received by a power tool (not shown). In particular, the collet 202 is received by an operational portion of a power tool so that the power tool can transmit rotational force to the adapter 222, to thereby cause rotation of the snake assembly 14. For example, the collet 202 is received within a chuck of a drill. The chuck of the drill will then transmit rotational force to the adapter 22, which will in turn, rotate the snake assembly 14 within a drain.

The collet 102 includes slits 214 extending axially along the length of the adapter 222. As described above with respect to the first embodiment, the slits 214 provide additional space within the hollow passageway 290 to make it easier to receive the snake 26 when the collet 202 is not received in a power tool. When the collet 202 is inserted into the power tool, the slits 214 are compressed and the snake 26 is clamped within the collet 202

When the linkage 218 and the adapter 222 are used with the snake assembly 14, can be assembled as follows. As described above, the snake assembly is formed by threading the snake 26 through the conduit 30. The second end of the snake 26 is threaded through the adapter 222. The first linkage member 218a and the second linkage member 218b are the connected together via the tabs 224 and the recesses 226 with the connection portion 294 of the adapter 222 positioned therebetween to secure the adapter 222 within the linkage 218. The first engagement element 258 of the linkage 218 is then slid into the attachment member 34 to secure the linkage 218 to the snake assembly 14. Finally, the collet 202 is inserted into a power tool. It should be understood by a person of ordinary skill in the art that certain assembly steps can be performed in a different order than described herein. For example, in some embodiments, the first engagement element 258 of the linkage 218 is slide into the attachment member 34 prior to securing the adapter 22 between the first linkage member 218a and the second linkage member 218b.

The embodiment described above and illustrated in the figures are presented by way of example only and are not intended as a limitation upon the concepts and principles of the present invention. As such, it will be appreciated that various changes in the elements and their configuration and arrangement are possible without departing from the spirit and scope of the present invention. Various features and advantages of the invention are set forth in the following claims.

What is claimed is:

1. A drain cleaner comprising:
a snake configured to be inserted into a drain;
a conduit through which the snake extends, the conduit including an attachment member;
a linkage including a first engagement element on a first end and a second engagement element on a second end opposite the first end, the first engagement element coupled to the attachment member of the conduit; and
an adapter including a first end coupled to the second engagement element of the linkage and a second end configured to be received by an operation portion of a power tool.

2. The drain cleaner of claim 1, wherein the first engagement element of the linkage forms a male part and the attachment member of the conduit forms a female part that receives the male part.

3. The drain cleaner of claim 2, wherein the male part and the female part are snap fit together.

4. The drain cleaner of claim 1, wherein the adapter includes a passage extending between the first end and the second end of the adapter, and wherein the snake extends through the passage.

5. The drain cleaner of claim 4, wherein the snake is rotatably fixed relative to the adapter.

6. The drain cleaner of claim 4, wherein the second end of the adapter defines a collet having a slit along a length of the adapter.

7. The drain cleaner of claim 6, wherein the slit is compressible to a reduced width to clamp the snake within the adapter when the adapter is inserted into the power tool.

8. The drain cleaner of claim 1, wherein the first end of the adapter includes a connecting portion that is received within an aperture formed in the second end of the linkage.

9. The drain cleaner of claim 8, wherein the adapter and the linkage are snap fit together.

10. The drain cleaner of claim 1, wherein the conduit is rotatable relative to the snake.

11. The drain cleaner of claim 1, wherein the adapter is rotatable relative to the conduit.

12. The drain cleaner of claim 1, wherein the linkage is formed by a first linkage member and a second linkage member that are coupled together.

13. The drain cleaner of claim 12, wherein the first linkage member and the second linkage member are coupled together by a tab and recess.

14. A drain cleaner comprising:
a snake configured to be inserted into a drain; and
an adapter including
a first end and a second end, the first end configured to be received by an operation portion of a power tool,
a passageway extending between the first end and the second end, the passageway receiving the snake, and
a plurality of slits extending along the first end of the adapter, the slits being compressible when the first end of the adapter is received by the operation portion of the power tool.

15. The drain cleaner of claim 14, further comprising a conduit having a first end and a second end, the snake extending through the conduit.

16. The drain cleaner of claim 15, further comprising a linkage having a first engagement element on a first end and a second engagement element on a second end opposite the first end, the first engagement element coupled to the conduit, the second engagement element coupled to the adapter.

17. The drain cleaner of claim 16, wherein the linkage is formed by a first linkage member and a second linkage member that are coupled together.

18. A drain cleaner comprising:
a snake including a first end and a second end, the first end configured to be inserted into a drain;
a conduit having a first end and a second end, the snake extending through the conduit with a first end of the snake extending beyond the first end of the conduit and a second end of the snake extending beyond a second end of the conduit; and
an adapter including a passage that receives the second end of the snake, wherein the first end of the adaptor is configured to be received by an operation portion of a power tool, and the adaptor includes a clamp member to fixedly secure the second end of the snake relative to the adapter.

19. The drain cleaner of claim 18, wherein the first end of the adapter is a collet configured to compress the snake when the first end of the adapter is received by the operation portion of the power tool.

20. The drain cleaner of claim 18, further comprising a linkage having a first engagement element on a first end and a second engagement element on a second end opposite the first end, the first engagement element coupled to the conduit, the second engagement element coupled to the adapter.
